(19) United States
(12) Patent Application Publication
(10) Pub. No.: US 2010/0007113 A1
(43) Pub. Date: Jan. 14, 2010

(54) Rear suspension system for bicycles

(76) Inventors: David Earle, Watsonville, CA (US); Luther Beale, Portland, OR (US)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,405

(22) Filed: Jul. 10, 2009

Related U.S. Application Data
(60) Provisional application No. 61/129,678, filed on Jul. 11, 2008.

(51) Int. Cl. B62K 3/04

(52) U.S. Cl. 280/284

(57) ABSTRACT

A rear suspension system for bicycles includes a front triangle, a rear triangle and a shock absorbing unit pivotably connected between the front and rear triangles to allow the rear triangle to move at a regulated rate with regard to the front triangle. The seatstays of the rear triangle have two dropouts and two extension portions on two opposite ends thereof. The two dropouts each have a notch for engaging with a rear wheel shaft. The extension portions are pivotably connected to the shock absorbing unit and the front triangle. The chainstays have two respectively first ends thereof pivotably to the dropouts at two pivot points and two respective second ends pivotably connected to the seat tube. The pivot points are located above or on a line between a center of the bottom bracket and a center of the notches in the dropouts.

### REFERENCE TO RELATED APPLICATION

This Application is based on Provisional Patent Application Ser. No. 61/129,678, filed 11 Jul. 2008, currently pending.

### FIELD OF THE INVENTION

The present invention relates to a rear suspension system for bicycles, and allows for preferential movement of the rear axle. The present invention moves axle in path other than a consistent radius and allows for various paths, X and Y direction movements, based on the desired effect needed due to the style of riding the bicycle is designed for.

### BACKGROUND OF THE INVENTION

Bicycle suspensions rely on several parameters to achieve desired results for riding performance. Among the most important of these parameters is the travel path and the rate of chainstays lengthening (cCSL). Different styles of riding and different bike designs will vary greatly. Combining different shock rates, frame design styles, travel path/cCSL is critical to designing a superior bike for a given application. One very important factor is being able to control and change, as necessary, the travel path and cCSL.

The travel path is an important factor in controlling suspension bike ride characteristics. It directly effects how much force is transferred from the pedaling forces into the suspension and when designed correctly can minimize the amount of pedal bob (suspension movement due to pedal forces) and chain pull (force which pulls the chain backwards when a bump is hit).

Other factors such as shock rate can effect the same parameters and thus travel path must be designed with shock rate and other factors in mind. Having a linkage system that allows the travel path to be changed based on the pivot placement design allows for design of different and superior riding styles of bikes.

The travel path is the movement of the rear wheel as defined in X-Y coordinates starting from 0 travel and ending at the end of the full travel range as controlled by any variation of suspension design. To graph travel path a minimum number of measurement points are taken from 0 travel to full travel, typically 40 points or more are required for accurate graph. If less measurement points are used it is possible to miss important relatively small changes in the travel path.

U.S. Pat. Nos. 6,843,494, 5,628,524, 6,488,301, 6,206,397 are known to applicant and disclose different styles of designs respectively. These patents have different patterns of trace of the movement of the rear wheel. Taken U.S. Pat. No. 6,843,494, which issued on Jan. 18, 2005, to Rocky Mountain as an example, it provides a generally vertical wheel travel path and a generally constant rate of change throughout the range of travel. However, a constant rate of change of the chainstays length represents a constant force of pedal bob resistance. A constant rate of pedal bob resistance force is not needed in the system and a truly optimized system will change this force in different areas of travel to accommodate what effect on the suspension is needed in that particular area.

A second example of a different suspension design that preferentially varies travel path and cCSL is U.S. Pat. No. 5,628,524, issued May 13, 1997, and U.S. Pat. No. 6,206,397, issued Mar. 27, 2001, and U.S. Pat. No. 6,488,301, issued Dec. 3, 2002, and U.S. Pat. No. RE39,159, issued Jul. 11, 2006, to Klassen. Such patents claims to provide a S-Shaped travel path. While this travel path may be advantageous in some designs in others, for example, downhill specific application, may prove to be less desirable.

A third example of this is the suspension configuration in U.S. Pat. No. 5,899,480, issued May 4, 1999, to Leitner (Horst link). Such configuration, according to the brands which promote and sell such configuration, provides for a travel path of minimum rear travel and minimum chain growth and pedal feedback. However such a travel path may not be ideal in all applications, for example a medium travel bike (5-6 inches) which requires chain growth to provide for some corrective force to reduce bob effect.

### SUMMARY OF THE INVENTION

The present invention relates to a rear suspension system for bicycles and the system comprises a front triangle comprising a head tube, a top tube, a down tube and a seat tube, a rear triangle comprising two seatstays, two chainstays and the seat tube, and a shock absorbing unit which is connected between the front and rear triangles to allow the rear triangle to move at a regulated rate with regard to the front triangle. Two respective first ends of the top tube and the down tube are connected to the head tube. Two respective second ends of the top tube and the down tube are connected to the seat tube. A bottom bracket is fixed on a lower end of the seat tube. The seatstays have two dropouts (LH and RH) at two respective first ends thereof and two extension portions (LH and RH) extend from two respective second ends of the seatstays. The two dropouts each have a notch which is connected with a rear wheel shaft and the extension portions are pivotably connected to the shock absorbing unit and the front triangle. The chainstays have two respectively first ends thereof pivotably to the dropouts at pivot points and two respective second ends of the chainstays are pivotably connected to the seat tube. The pivot points are located on or above a line between a center of the bottom bracket and a center of the notches in the dropouts.

Those skilled in the arts will certainly realize that the following description can be changed significantly and still provide the desired effect outlined and covered in the scope of this patent.

The primary object of the present invention is to provide a rear suspension system for bicycles wherein the rear wheel movement can be specifically designed to provide for different paths based on specific bicycle application.

The present invention will become more obvious from the following description when taken in connection with the accompanying drawings which show, for purposes of illustration only, a preferred embodiment in accordance with the present invention.

The present invention intends to provide a rear suspension system for bicycles that allows slight variations in the system design to provide for different and varying trace movement of the rear wheel. Thus moving in an optimized path depending on the relative location of the rear wheel in its upward movement and also changes depending on the application. In some applications the system may work to minimize X movement in certain regions for certain applications and in other applications it may be designed to increase the amount of X direction movement.

While Rocky Mountain patent claims that contain information regarding a pivot near the dropouts that is higher than they line between the center of the dropouts and the center of the BB we are clearly different than Rocky Mountain design in the following ways.

Rocky Mountain's Frame design and architecture uses a lower Link in place of a conventional chainstay arm assembly (such chainstay assembly is shown clearly in both our claims and drawings and the claims and drawings of similar system shown in other prior art of the Horst link), the present invention uses a standard chainstay arm assembly with a pivot at the BB end near the BB and a dropout pivot near the dropout.

Rocky Mountain patent claim the goal of the function of their system is to provide a generally vertical wheel travel path and provide a generally constant rate of change throughout the range of travel. While they do very effectively do this with their design, the theory is fundamentally incorrect. A constant rate of change of the CS length represents a constant force of pedal bob resistance. A constant rate of pedal bob resistance force is not needed in the system and a truly optimized system will change this force in different areas of travel to accommodate what effect on the suspension is needed in that particular area. In effect, what they claim to be a bad characteristic in the Klassen patents is actually a good a meaningful characteristic for bicycle performance.

The present invention is clearly different from the Rocky Mountain patent in that it uses substantial and meaningfully placed changes in the rate of CS lengthening to give a superior ride. A ride that minimizes pedal bob in areas of suspension travel that increased resistance force is needed and lessens chainstay lengthening (pedal feedback) in areas that pedal bob is not an issue. The inconsistent suspension behavior that Rocky Mountain points to in Klassen designs are myth, current popularity and outstanding performance reviews of such systems are telling.

The function of the Klassen patents is similar to the present invention. However the specific function and claims of the Klassen patents are very different than the function of the present invention. Refer to the FIG. 5 of the systems that clearly show the difference.

The architecture of the present invention differs very specifically from the Leitner (Horst link System) patent. Leitner (Horst link System) clearly puts the pivot of the chainstay arm near the dropout below the rear wheel hub centerline the present invention is clearly raised above this point.

The stated goal of the Leitner (Horst link System) patent is to isolate rider forces from the suspension system. The function of the present invention pivot system is to integrate the rider pedal forces into the system and use them to improve the overall performance of the system.

### BRIEF DESCRIPTION OF THE DRAWINGS

FIG. 1 is a side view to show the rear suspension system of the present invention;

FIG. 2 is a side view of the rear suspension system of the present invention and shows the trace axle path when the rear suspension system is activated;

FIG. 3 is a chart to show the travel path of one configuration of the preferred embodiment under in X-Y coordinates.

FIG. 4 is a side view to show another embodiment of the rear suspension system of the present invention.

FIG. 5 is a chart to show the travel path of the Klassen patents.

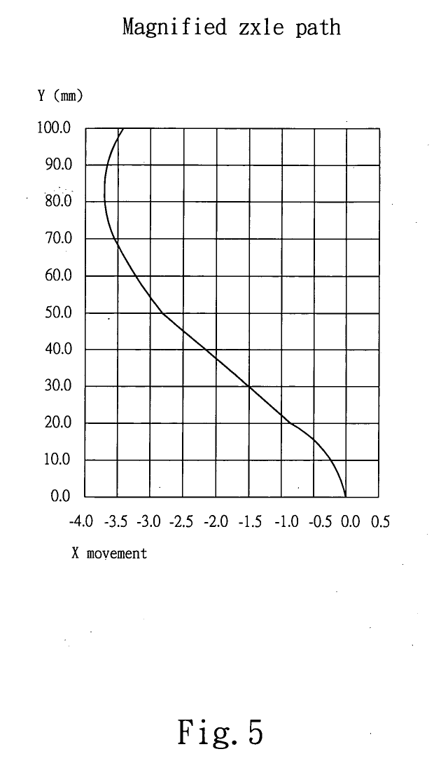

### DETAILED DESCRIPTION OF THE PREFERRED EMBODIMENT

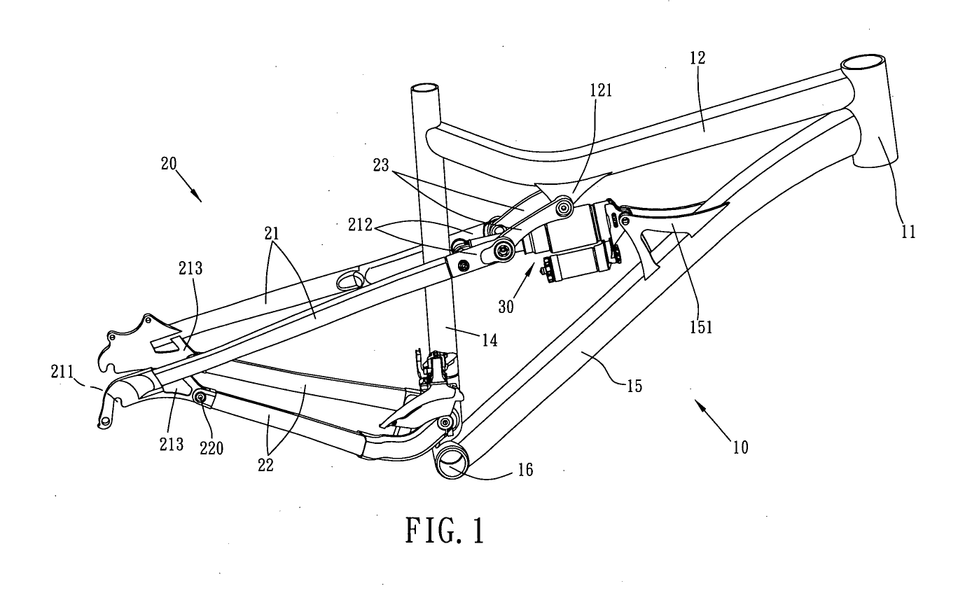

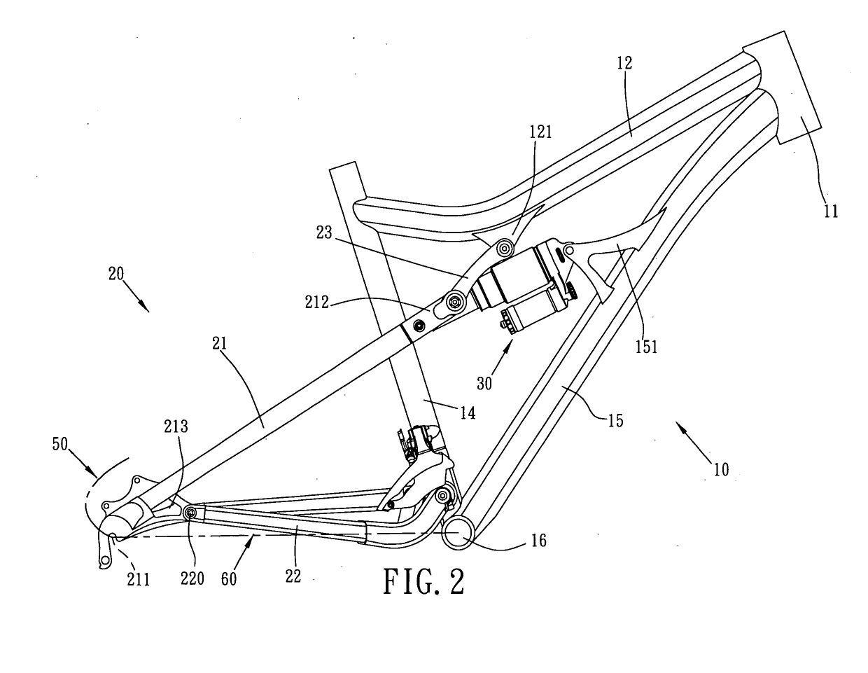

Referring to FIGS. 1 and 2, the rear suspension system of the present invention is designed and used for a bicycle which comprises a frame composed of a front triangle 10 and a rear triangle 20, wherein the front triangle 10 comprises a head tube 11, a top tube 12, a down tube 15 and a seat tube 14. Two respective first ends of the top tube 12 and the down tube 15 are connected to the head tube 11 and respective second end of the top tube 12 connected to the seat tube 14, respective second end of and the down tube 15 is connected to the bottom bracket shell 16. The head tube 11 enables placement of a standard steering unit (not shown) and a front wheel (not shown). A bottom bracket 16 is fixed on a lower end of the seat tube 14 and lower end of down tube 15, bottom bracket also serves to mount the crank and pedal assembly.

The rear triangle 20 comprises two seatstays 21, two chainstays 22. Wherein the seatstays 21 have two dropouts (LH and RH) 213 at two respective first ends thereof and two extension portions 212 extend from two respective second ends of the seatstays 21. The two dropouts 213 each have a notch 211 with which a rear wheel shaft is engaged. The extension portions 212 extend beyond the seat tube 14 into the area of the front triangle 10.

A shock absorbing unit 30 is connected between the front and rear triangles 10, 20 respectively. It allows the rear triangle 20 to move at a regulated rate with respect to to the front triangle 10. The extension portions 212 are pivotably connected to an end of the shock absorbing unit 30. The down tube 15 includes a protrusion, (bracket) 151 and the top tube 12 includes a protrusion, (bracket) 121. Two ends of the shock absorbing unit 30 are pivotably connected to the down tube protrusion 151 and the extensions 212 of the seatstays 21 respectively. Two members 23 are pivotally connected between the top tube protrusion 121 and the two extensions 212.

The chainstays 22 have two first ends thereof pivotally connected to the dropouts 213 at pivot points 220 and two respective second ends of the chainstays 22 are pivotably connected to the seat tube 14, The pivot points 220 are located above a line 60 between a center of the bottom bracket 16 and a center of the notches 211 in the dropouts 213.

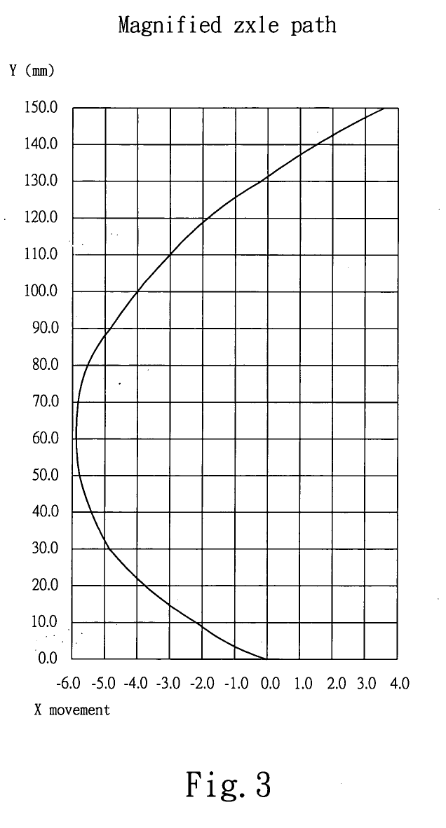

When the rear suspension system is activated, the rear triangle 20 and the rear wheel are moved up and down and the shock absorbing unit 30 is activated by the movement of the seatstays 21. The chainstays 22 are pivoted at the pivot points 220 and at the seat tube 14. The trace 50 of the rear wheel that is engaged at the notches 211 is shown by the phantom line. The trace 50 moves in X-axis direction and Y-axis direction as shown in FIG. 3. The ability to preferentially control the distance of movement in X-axis direction represents that the rear suspension system provides the means to tune and control the important suspension parameter; axle path and cCSL rate.

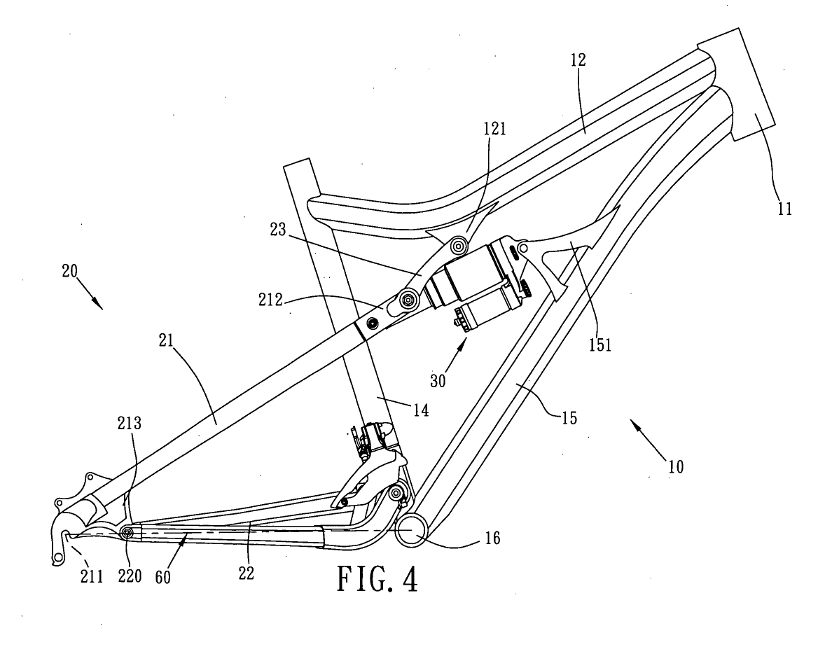

FIG. 4 shows another embodiment of the rear suspension system of the present invention, wherein the pivot points 220 are located on the line 60 between a center of the bottom bracket 16 and a center of the notches 211 in the dropouts 213.

While we have shown and described the embodiment in accordance with the present invention, it should be clear to those skilled in the art that further embodiments may be made without departing from the scope of the present invention.

What is claimed is:

1. A rear suspension system for bicycles, comprising:
a front section known as a front triangle and a rear section known as a rear triangle. The rear triangle is connected to said front triangle using any number of connection methods which may or may not employ bearings, bushings, axles, clamps and flexible links. A shock absorbing unit is connected between the front and the rear to allow the rear to move at a regulated rate with regard to the front, any number of different connection methods for controlling the rate of movement can be used. The front section is typically but not in all cases comprised of a tube which carries the seat, a tube which carries the steering apparatus, and a tube which carries a crank assembly. These three tubes are connected together in any number of different ways to form the front section. The front may have a single point of connection between the two (front and rear) or multiple points of connection using any number of different connection methods and pivot and or link configurations. The rear section is typically comprised of a part to mount a wheel, considered in most cases the rear wheel, this part is known as the dropout. A upper set of tubes known as the seatstays to which rigidly connected at one end is the aforementioned dropout, the opposite end can have any number of different connections including to links, flexible pivots, eccentrics and connection points. The aforementioned rear triangle also has a lower arm structure which is known as the chainstays. This lower arm structure has the end furthest away from the dropout connected to the front triangle at what is considered the lower or main pivot. This main pivot consists of, bearings, bushings, axles, clamps, standard links and flexible links. The opposite end of the Chainstay arm has a pivot which can include but is not limited to, bearing, bushing, flexible pivots, and eccentrics. The location of this pivot is at a specific location: Specifically, when a theoretical line is drawn from the centerline of the tube on the front triangle which carries the crank assembly to the centerline of where the rear wheel is held in the dropout, the pivot that is on the end of the Chainstay arm attached to the dropout is specifically above that line.

2. A rear suspension system for bicycles, comprising:
a front section known as a front triangle and a rear section known as a rear triangle. The rear triangle is connected to said front triangle using any number of connection methods which may or may not employ bearings, bushings, axles, clamps and flexible links. A shock absorbing unit is connected between the front and the rear to allow the rear to move at a regulated rate with regard to the front, any number of different connection methods for controlling the rate of movement can be used. The front section is typically but not in all cases comprised of a tube which carries the seat, a tube which carries the steering apparatus, and a tube which carries a crank assembly. These three tubes are connected together in any number of different ways to form the front section. The front may have a single point of connection between the two (front and rear) or multiple points of connection using any number of different connection methods and pivot and or link configurations. The rear section is typically comprised of a part to mount a wheel, considered in most cases the rear wheel, this part is known as the dropout. A upper set of tubes known as the seatstays to which rigidly connected at one end is the aforementioned dropout, the opposite end can have any number of different connections including to links, flexible pivots, eccentrics and connection points. The aforementioned rear triangle also has a lower arm structure which is known as the chainstays. This lower arm structure has the end furthest away from the dropout connected to the front triangle at what is considered the lower or main pivot. This main pivot consists of, bearings, bushings, axles, clamps, standard links and flexible links. The opposite end of the Chainstay arm has a pivot which can include but is not limited to, bearing, bushing, flexible pivots, and eccentrics. The location of this pivot is at a specific location: Specifically, when a theoretical line is drawn from the centerline of the tube on the front triangle which carries the crank assembly to the centerline of where the rear wheel is held in the dropout, the pivot that is on the end of the Chainstay arm most that attaches to the dropout is specifically falls directly on this line.
